(19) United States
(12) Patent Application Publication
(10) Pub. No.: US 2026/0093631 A1
(43) Pub. Date: Apr. 2, 2026

(54) SYSTEMS AND METHODS FOR MIXED DIRECTORY ENTRY ORGANIZATION IN PROBE FILTER

(71) Applicant: Advanced Micro Devices, Inc., Santa Clara, CA (US)

(72) Inventors: Ganesh Balakrishnan, Austin, TX (US); Amit P. Apte, Austin, TX (US)

(73) Assignee: Advanced Micro Devices, Inc., Santa Clara, CA (US)

(21) Appl. No.: 18/899,836

(22) Filed: Sep. 27, 2024

(51) Int. Cl. G06F 12/0817; G06F 12/0871

(52) U.S. Cl. CPC G06F 12/0817; G06F 12/0871

(57) ABSTRACT

A computing system includes a first processing node having one or more processors and a cache subsystem, and a probe filter directory having entries for tracking a plurality of memory locations wherein data stored at the plurality of memory locations are cached in the cache subsystem, the probe filter directory including a first entry for tracking a first memory location of the plurality of memory locations, the first entry taking up a first number of bits, and a second entry for tracking a second memory location of the plurality of memory locations, the second entry taking up a second number of bits, wherein the first number is larger than the second number. Various other methods and systems are also disclosed.

### BACKGROUND

Computer systems use main memory that is typically formed with inexpensive and high density dynamic random access memory (DRAM) chips. However, DRAM chips suffer from relatively long access times. To improve performance, a computer system typically includes at least one local, high-speed memory known as a cache. In a multi-core data processor, each data processor core can have its own dedicated level one (L1) cache, while other caches (e.g., level two (L2), level three (L3)) are shared by data processor cores.

Cache subsystems in a computing system include high-speed cache memories configured to store blocks of data. As used herein, a “block” is a set of bytes stored in contiguous memory locations, which are treated as a unit for coherency purposes. As used herein, each of the terms “cache block”, “block”, “cache line”, and “line” is interchangeable. In some examples, a block can also be the unit of allocation and deallocation in a cache. The number of bytes in a block is varied according to design choice, and can be of any size. In addition, each of the terms “cache tag”, “cache line tag”, and “cache block tag”is interchangeable.

In multi-node computer systems, special precautions must be taken to maintain coherency of data that is being used by different processing nodes. For example, if a processor attempts to access data at a certain memory address, it must first determine whether the memory is stored in another cache and has been modified. To implement this cache coherency protocol, caches typically contain multiple status bits to indicate the status of the cache line to maintain data coherency throughout the system. One common coherency protocol is known as the “MOESI” protocol. According to the MOESI protocol, each cache line includes status bits to indicate which MOESI state the line is in, including bits that indicate that the cache line has been modified (M), that the cache line is exclusive (E) or shared(S), or that the cache line is invalid (I). The Owned (O) state indicates that the line is modified in one cache, that there may be shared copies in other caches and that the data in memory is stale.

Cache directories are a key building block in high performance scalable systems. A cache directory is used to keep track of the cache lines that are currently in use by the system. A cache directory improves both memory bandwidth as well as reducing probe bandwidth by performing a memory request or probe request only when required. Logically, the cache directory resides at the home node of a cache line which enforces the cache coherence protocol. The operating principle of a cache directory is inclusivity (i.e., a line that is present in a central processing unit (CPU) cache must be present in the cache directory). The size of the cache directory increases linearly with the total capacity of all of the CPU cache subsystems in the computing system. Over time, CPU cache sizes have grown significantly. As a consequence of this growth, cache directory has become very large.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary computing system.

FIG. 2 is a block diagram of an exemplary core complex.

FIG. 3 is a block diagram of an exemplary multi-CPU system.

FIG. 4 is a block diagram of an implementation of a cache directory.

FIG. 5 is a block diagram of another implementation of a cache directory.

FIG. 6 is a block diagram of another implementation of a cache directory.

FIG. 7 is a block diagram of an exemplary region-based cache directory.

FIGS. 8A and 8B are block diagrams illustrating an exemplary regular directory entry and an exemplary narrow directory entry, respectively.

FIG. 9 is a flowchart illustrating an exemplary process for increasing the capacity of a probe filter directory by mixing regular and narrow entries.

FIG. 10 is a flowchart illustrating another exemplary process for increasing the capacity of a probe filter directory by mixing regular and narrow entries.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to probe filters for enhancing cache coherency in a computing system. Specifically, the disclosed probe filters mix regular entries with narrow entries in a filter directory. A narrow entry occupies fewer number of bits than a regular entry, so that a mixed filter directory can accommodate more entries than a conventional uniform filter directory of a same size. However, there are tradeoffs. By reducing number of bits, the narrow entry tracks core complexes with reduced fidelity. Such loss of fidelity exemplarily manifests in that some core complexes are not tracked and need to be probed unconditionally.

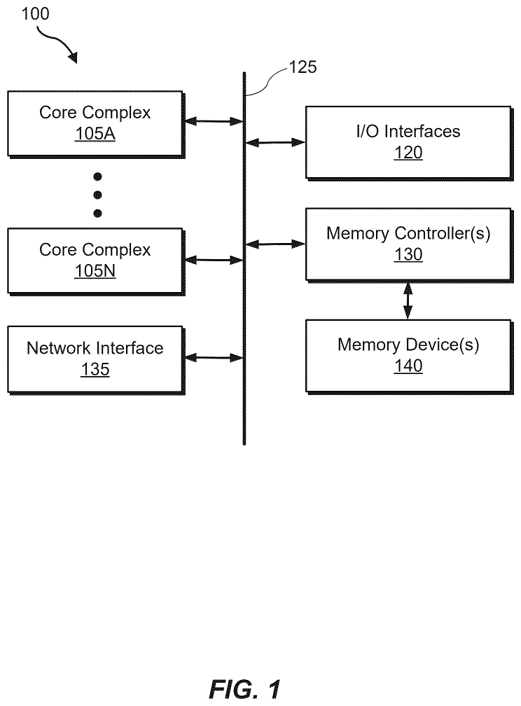

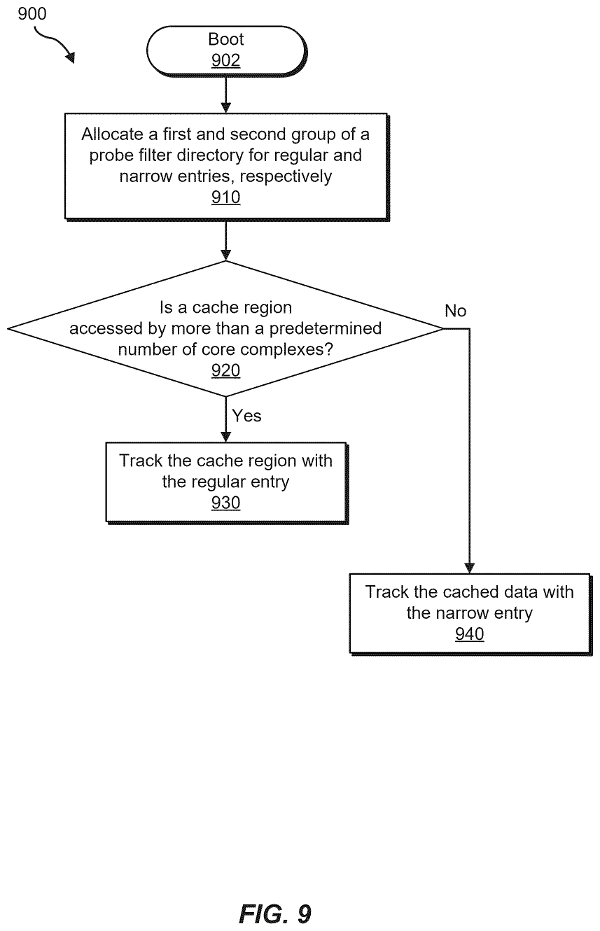

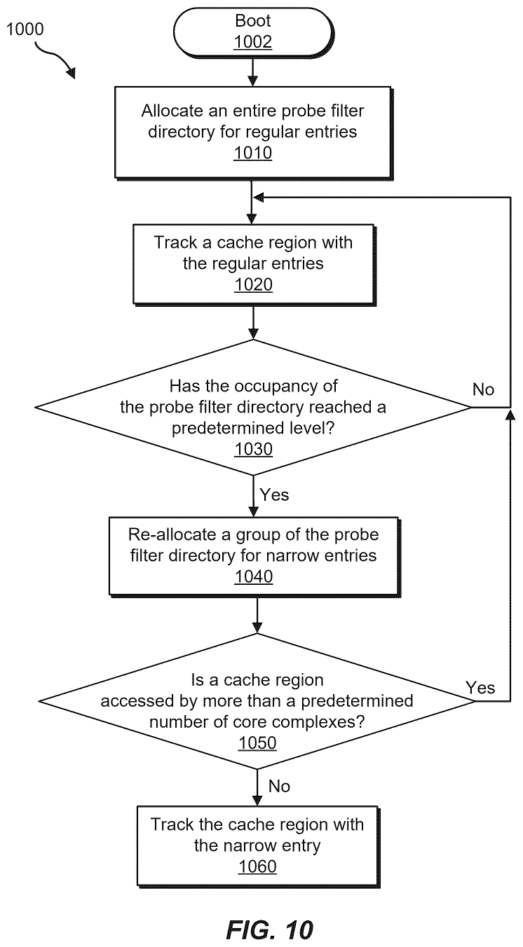

The following will provide, with reference to FIGS. 1-8, detailed descriptions of example systems for probe filter directory. Detailed descriptions of corresponding computer-implemented methods will also be provided in connection with FIG. 9-10.

An exemplary system includes a first processing node including one or more processors and a cache subsystem, a memory accessible by the processing node, and a probe filter directory having entries for tracking memory locations in the memory wherein data stored at the memory locations are cached in the cache subsystem, the probe filter directory including: a first entry for tracking a first memory location in the memory, the first entry taking up a first number of bits, and a second entry for tracking a second memory location in the memory, the second entry taking up a second number of bits, wherein the first number of bits is larger than the second number of bits.

In an example, the above first memory location include a first and second line of the memory, data at the first line being accessed by a first processing node of a system and data at the second line being accessed by a second processing node of the system.

In another example, the above first and the second processing node share a bus or fabric.

In another example, data at the above second memory location is accessed only by the first processing node.

In another example, the above first and second entry have a same number of fields, and every field in the first entry has a corresponding field in the second entry, wherein a first field in the first entry takes up a larger number of bits than a corresponding field in the second entry, while a second field in the first entry takes up a same number of bit as a corresponding field in the second entry.

In another example, the above first and second entry have a same number of fields, and every field in the first entry has a corresponding field in the second entry. In an implementation, a first field in the first entry takes up a larger number of bits than a corresponding field in the second entry while a second field in the first entry takes up a same number of bit as a corresponding field in the second entry.

In another example, the first and second memory locations in the memory are single lines in the memory.

In another example, the first and second entry have a same number of fields, and every field in the first entry has a corresponding field in the second entry.

In another example, a first field in the first entry takes up a larger number of bits than a corresponding field in the second entry while a second field in the first entry takes up a same number of bits as a corresponding field in the second entry.

In another example, the first field is a core complex tracker configured to track a processor that owns the data from the location in the memory where the data is cached in the cache subsystem.

In another example, a collection of x number of the above first entries takes up a same number of bits as a collection of y number of the above second entries, where x and y are integers larger than 1 based on a ratio corresponding to a ratio of the first number of bits and the second number of bits.

An exemplary method including providing a processing node including one or more processors and a cache subsystem, providing a memory accessible by the processing node, providing a probe filter directory having entries for tracking memory locations in the memory wherein data stored at the memory locations are cached in the cache subsystem, constructing a first entry of the probe filter directory for tracking a first memory location in the memory, the first entry taking up a first number of bits, and constructing a second entry of the probe filter directory for tracking a second memory location in the memory, the second entry taking up a second number of bits, wherein the first number of bits is larger than the second number of bits.

In an example, the above constructing the first and second entries includes determining a composition of a first type of entry for the first entry and a second type of entry for the second entry during a boot process for the first processing node. In another example, the composition of first and second type of entry may shift based on the application's need at run time.

In another example, the second entry is re-allocated from having the first number of bits to having the second number of bits in response to an occupancy of the probe filter directory reaching a predetermined level.

In another example, the first memory location includes a first and second line of the memory, data at the first line being accessed by a first processing node of a system and data at the second line being accessed by a second processing node of the system.

FIG. 1 is a block diagram of an exemplary computing system 100. As illustrated in this figure, exemplary computing system 100 includes at least core complexes 105A-N, input/output (I/O) interfaces 120, bus 125, memory controller 130, network interface 135, memory device 140, and processing-in-memory device 150. In other implementations, computing system 100 can include other components and/or computing system 100 can be arranged differently. In an implementation, each core complex 105A-N includes one or more general purpose processors, such as central processing units (CPUs). It is noted that a “core complex” can also be referred to as a “processing node” a “CPU”, a “processor”, or an “accelerator” herein. In some implementations, one or more core complexes 105A-N can include a data parallel processor with a highly parallel architecture. Examples of data parallel processors include graphics processing units (GPUs), digital signal processors (DSPs), field programmable gate arrays (FPGAs), application specific integrated circuits (ASICs), and so forth. Each processor core within core complex 105A-N includes a cache subsystem with one or more levels of caches. In an example, each core complex 105A-N includes a cache (e.g., level three (L3) cache) which is shared between multiple processor cores.

Memory controller(s) 130 are representative of any number and type of memory controllers accessible by core complexes 105A-N. Memory controller(s) 130 are coupled to any number and type of memory devices 140. Depending on implementations, the type of memory in memory devices 140 coupled to memory controllers 130 can include Dynamic Random Access Memory (DRAM), Static Random Access Memory (SRAM), NAND Flash memory, NOR Flash memory, Ferroelectric Random Access Memory (FeRAM), or other types.

I/O interfaces 120 are representative of any number and type of I/O interfaces (e.g., peripheral component interconnect (PCI) bus, PCI-Extended (PCI-X), PCI Express (PCIe) bus, gigabit Ethernet (GBE) bus, universal serial bus (USB)). Various types of peripheral devices can be coupled to I/O interface 120. Such peripheral devices include (but are not limited to) displays, keyboards, mice, printers, scanners, joysticks or other types of game controllers, media recording devices, external storage devices, network interface cards, and so forth.

In various implementations, computing system 100 can be a server, personal computer, laptop, mobile device, game console, streaming device, wearable device, or any of various other types of computing systems or devices. It is noted that the number of components in computing system 100 can vary from implementation to implementation. There can be more or fewer of each component than the number shown in FIG. 1. It is also noted that computing system 100 can include other components not shown in FIG. 1. Additionally, in other implementations, computing system 100 can be structured in other ways than shown in FIG. 1.

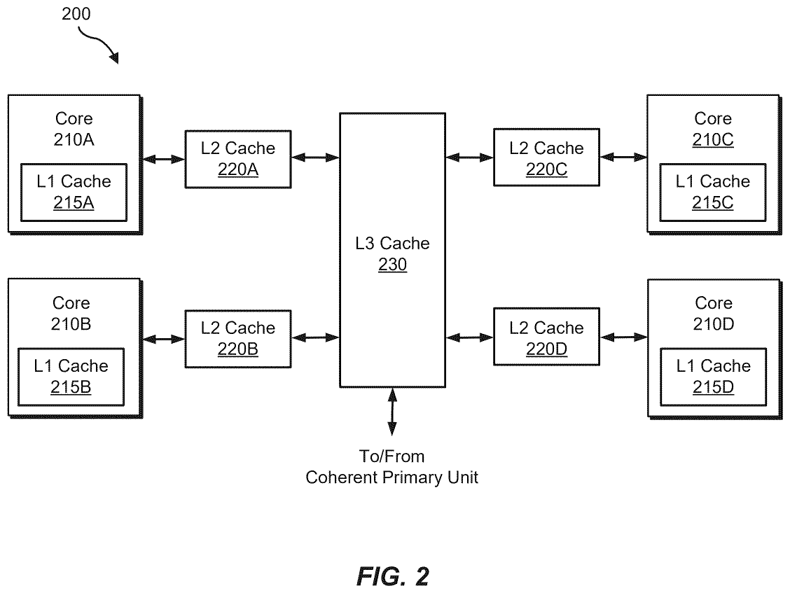

FIG. 2 is a block diagram of an exemplary core complex 200. In one implementation, core complex 200 includes four processor cores 210A-D. In other implementations, core complex 200 can include other numbers of processor cores. It is noted that a “core complex” can also be referred to as a “processing node”, “accelerator”, “processor” or “CPU” herein. In one example, the components of core complex 200 are included within core complexes 105A-N of FIG. 1.

Each processor core 210A-D includes a cache subsystem for storing data and instructions retrieved from the memory subsystem (not shown). For example, each core 210A-D includes a corresponding level one (L1) cache 215A-D. Each processor core 210A-D can include or be coupled to a corresponding level two (L2) cache 220A-D. Additionally, in one implementation, core complex 200 includes a level three (L3) cache 230 which is shared by the processor cores 210A-D exemplarily through L2 caches 220A-D. L3 cache 230 is also exemplarily coupled to a coherent master (not shown) for access to the fabric and memory subsystem. It is noted that in other embodiments, core complex 200 can include other types of cache subsystems with other numbers of caches and/or with other configurations of the different cache levels.

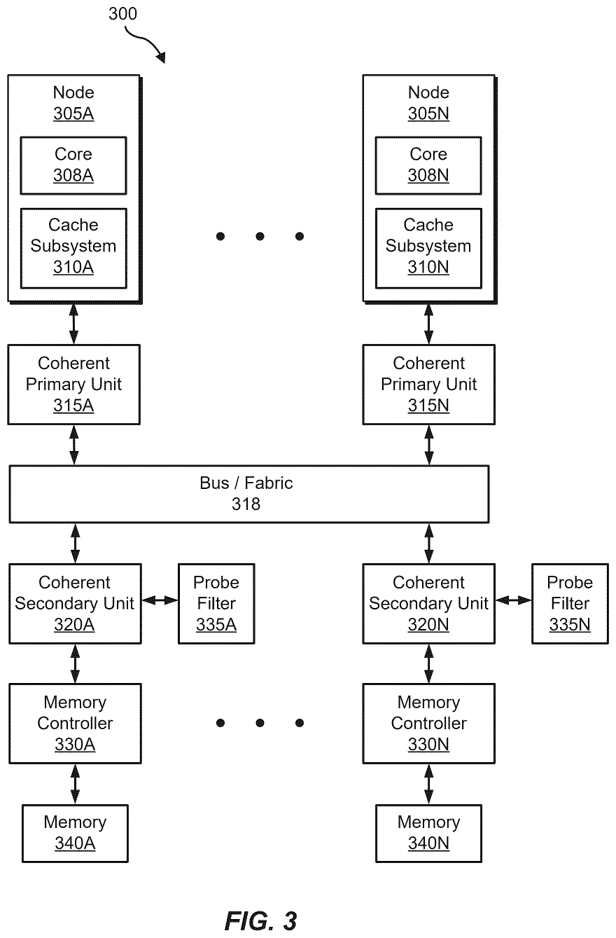

FIG. 3 is a block diagram of an exemplary multi-CPU system 300. System 300 includes multiple nodes 305A-N, with the number of nodes per system varying from implementation to implementation. Each node 305A-N can include any number of cores 308A-N, respectively, with the number of cores varying according to the implementation and from node to node. Each node 305A-N also includes a corresponding cache subsystem 310A-N, respectively. Each cache subsystem 310A-N can include any number of cache levels and any type of cache hierarchical structure.

In one implementation, each node 305A-N is coupled to a corresponding coherent primary unit 315A-N. As used herein, a “coherent primary unit” is defined as an agent that processes traffic flowing over an interconnect (e.g., bus/fabric 318) and manages coherency for a connected node. To manage coherency, a coherent primary unit 315A-N receives and processes coherency-related messages and probes and generates coherency-related requests and probes.

In one implementation, each node 305A-N is coupled to a corresponding coherent secondary (CS) unit 320A-N via a corresponding coherent primary unit 315A-N and bus/fabric 318. For example, node 305A is coupled through coherent primary unit 315A and bus/fabric 318 to coherent secondary unit 320A. Coherent secondary unit 320A is coupled to memory 340A via memory controller (MC) 330A. Coherent secondary unit 320A is also coupled to or includes probe filter 335A, with probe filter 335A including entries for cache lines cached in system 300 for the memory 340A accessible through memory controller 330A. Probe filter 335A determines whether to issue a probe to at least one other processing node in response to a memory access request.

It is noted that probe filter 335A, and each of the other probe filters, can also be referred to as a “cache directory”. It is also noted that the example of having one memory controller per node is merely indicative of one implementation. It should be understood that in other implementations, each node 305A-N can be connected to other numbers of memory controllers.

In a similar configuration to that of node 305A, node 305N is coupled to coherent secondary units 320N via coherent primary unit 315N and bus/fabric 318. Coherent secondary unit 320N is coupled to or includes probe filter 335N for coherency purposes, and coherent secondary unit 320N is coupled to memory 340N via memory controllers 330N. As used herein, a “coherent secondary unit” is defined as an agent that manages coherency by processing received requests and probes that target a corresponding memory controller. Additionally, as used herein, a “probe” is defined as a message passed from a coherency point to one or more caches in the computer system 300 to determine if the caches have a copy of a block of data and optionally to indicate the state into which the cache should place the block of data and/or trigger a write-back of dirty data in the cache.

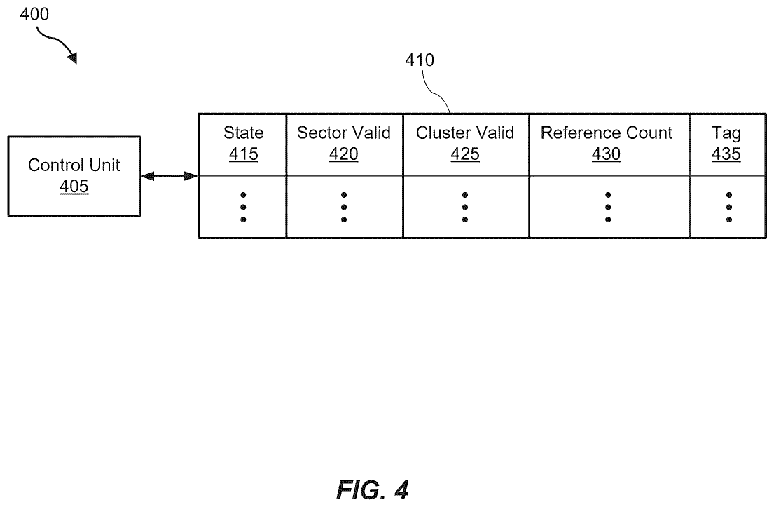

FIG. 4 is a block diagram of an implementation of a cache directory 400. In this implementation, cache directory 400 includes control unit 405 (e.g., a controller or circuitry) and array 410 (e.g., a data structure). Array 410 can include any number of entries, with the number of entries varying according to the implementation. In one implementation, each entry of array 410 includes a state field 415, sector valid (SecVal) field 420, cluster valid field 425, reference count field 430, and tag field 435. In other implementations, the entries of array 410 can include other fields and/or can be arranged in other suitable manners.

State field 415 includes state bits that specify the aggregate state of the region. The aggregate state reflects the most restrictive cache line state for this particular region. For example, the state for a given region is stored as “dirty” even if only a single cache line for the entire given region is dirty. Also, the state for a given region is stored as “shared” even if only a single cache line of the entire given region is shared.

Sector valid field 420 stores a bit vector corresponding to sub-groups or sectors of lines within the region to provide fine grained tracking. By tracking sub-groups of lines within the region, the number of unwanted regular coherency probes and individual line probes generated while unrolling a region invalidation probe can be reduced. As used herein, a “region invalidation probe” is defined as a probe generated by the cache directory in response to a region entry being evicted from the cache directory. When a coherent master receives a region invalidation probe, the coherent master invalidates each cache line of the region that is cached by the local CPU. Additionally, tracker and sector valid bits are included in the region invalidate probes to reduce probe amplification at the CPU caches.

The organization of sub-groups and the number of bits in sector valid field 420 can vary according to the implementation. In one implementation, two lines are tracked within a particular region entry using sector valid field 420. In another implementation, other numbers of lines can be tracked within each region entry. In this implementation, sector valid field 420 can be used to indicate the number of partitions that are being individually tracked within the region. Additionally, the partitions can be identified using offsets which are stored in sector valid field 420. Each offset identifies the location of the given partition within the given region. Sector valid field 420, or another field of the entry, can also indicate separate owners and separate states for each partition within the given region.

Cluster valid field 425 includes a bit vector to track the presence of the region across various CPU cache clusters. For example, in one implementation, CPUs are grouped together into clusters of CPUs. The bit vector stored in cluster valid field 425 is used to reduce probe destinations for regular coherency probes and region invalidation probes.

Reference count field 430 is used to track the number of cache lines of the region which are cached somewhere in the system. On the first access to a region, an entry is installed in array 410 and the reference count field 430 is set to one. Over time, each time a cache accesses a cache line from this region, the reference count is incremented. As cache lines from this region get evicted by the caches, the reference count decrements. Eventually, if the reference count reaches zero, the entry is marked as invalid, and the entry can be reused for another region. By utilizing the reference count field 430, the incidence of region invalidate probes can be reduced. The reference count filed 430 allows directory entries to be reclaimed when an entry is associated with a region with no active subscribers. In one embodiment, the reference count field 430 can saturate once the reference count crosses a threshold. The threshold can be set to a value large enough to handle private access patterns while sacrificing some accuracy when handling widely shared access patterns for communication data.

Tag field 435 includes the tag bits that are used to identify the entry associated with a particular region.

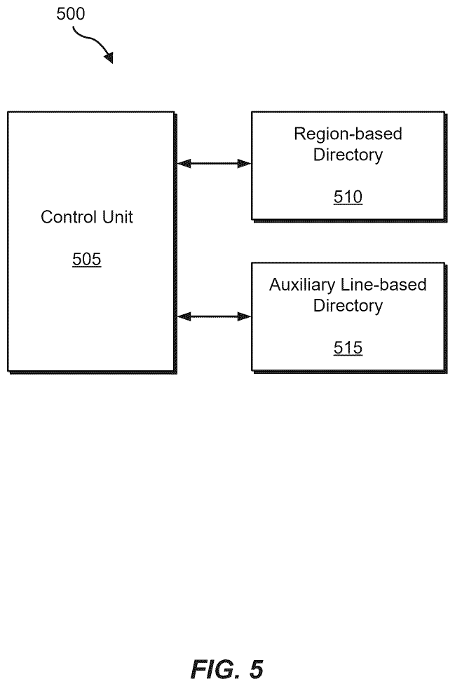

FIG. 5 is a block diagram of another implementation of a cache directory 500. In this implementation, cache directory 500 includes at least control unit 505 (e.g., a controller or circuitry) coupled to region-based cache directory 510 (e.g., a data structure) and auxiliary line-based directory 515 (e.g., a data structure). Region-based cache directory 510 includes entries to track cached data on a region-basis. In one implementation, each entry of region-based cache directory 510 includes a reference count to count the number of accesses to cache lines of the region that are cached by the cache subsystems of the computing system (e.g., system 300 of FIG. 3). In one implementation, when the reference count for a given region reaches a threshold, the given region will start being tracked on a line-basis by auxiliary line-based directory 515.

In one implementation, only shared regions that have a reference count greater than a threshold will be tracked on a cache line-basis by auxiliary line-based directory 515. A shared region refers to a region that has cache lines stored in cache subsystems of at least two different CPUs. A private region refers to a region that has cache lines that are cached by only a single CPU. Accordingly, in one implementation, for shared regions that have a reference count greater than a threshold, there will be one or more entries in the line-based directory 515. In this implementation, for private regions, there will not be any entries in the line-based directory 515.

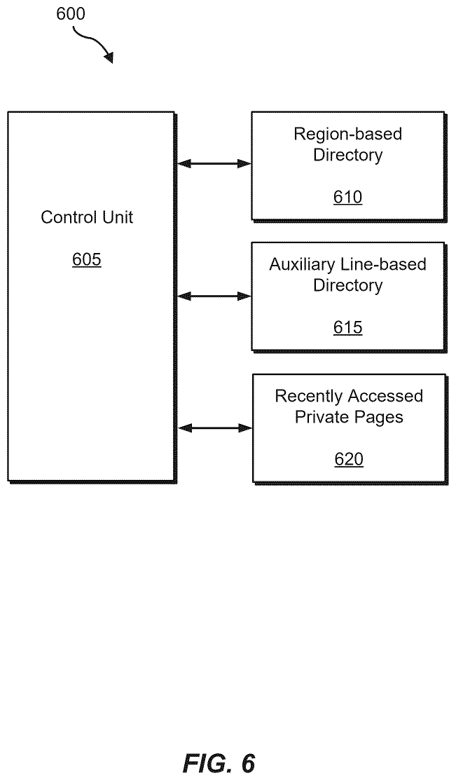

FIG. 6 is a block diagram of another implementation of a cache directory 600. In this implementation, cache directory 600 includes control unit 605 (e.g., a controller or circuitry), region-based cache directory 610 (e.g., a data structure), auxiliary line-based directory 615 (e.g., a data structure), and recently accessed private pages 620 (e.g., a data structure) for caching the N most recently accessed private pages. It is noted that N is a positive integer which can vary according to different implementations.

In one implementation, recently accessed private pages 620 includes storage locations to temporarily cache entries for the last N visited private pages. When control unit 605 receives a memory request or invalidation request that matches an entry in recently accessed private pages 620, control unit 605 is configured to increment or decrement the reference count, modify the cluster valid field and/or sector valid field, etc. outside of the directories 610 and 615. Accordingly, rather than having to read and write to entries in directories 610 and 615 for every access, accesses to recently accessed private pages 620 can bypass accesses to directories 610 and 615. The use of recently accessed private pages 620 can help speed up updates to cache directory 600 for these private pages.

In one implementation, I/O transactions that are not going to modify the sector valid or the cluster valid bits can benefit from recently accessed private pages 620 for caching the N most recently accessed private pages. Typically, I/O transactions will only modify the reference count for a given entry, and rather than performing a read and write of directory 610 or 615 each time, recently accessed private pages 620 can be updated instead.

Accordingly, recently accessed private pages 620 enables efficient accesses to the cache directory 600. In one implementation, incoming requests perform a lookup of recently accessed private pages 620 before performing lookups to directories 610 and 615. In one implementation, while an incoming request is allocated in an input queue of a coherent slave (e.g., coherent secondary unit 320A of FIG. 3), control unit 605 determines whether there is a hit or miss in recently accessed private pages 620. Later, when the request reaches the head of the queue, control unit 605 already knows if the request is a hit in recently accessed private pages 620. If the request is a hit in recently accessed private pages 620, the lookup to directories 610 and 615 can be avoided.

In some examples, increasing coverage (e.g., tracking more regions/lines of cache) is desirable, particularly with larger cache structures. However, adding additional entries by increasing a size of a data structure for a cache directory can be undesirable or otherwise unfeasible. Accordingly, the systems and methods described herein provide for increasing a number of entries in the cache directory by selectively reducing a size of certain entries. For example, certain regions can be tracked with fewer bits (e.g., private regions/pages being accessed by a limited number of CPUs) as will be described further below.

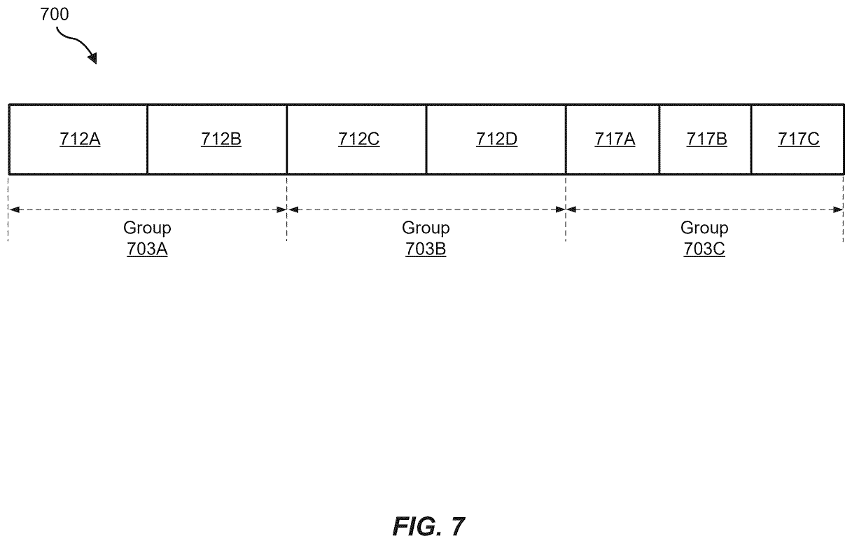

FIG. 7 is a block diagram of an exemplary region-based cache directory 700. In an implementation, region-based cache directory 700 is divided into three groups 703A-C of equal number of bits. Group 703A accommodates two directory entries 712A and 712B; group 703B also accommodates two directory entries 712C and 712D; but group 703C accommodates three directory entries 717A, 717B and 717C. Directory entries 712A-D take up the same first number of bits. Directory entries 717A-C take up the same second number of bits. The first number of bits is higher than the second number of bits, so that each of group 703A and 703B can accommodate only two directory entries 712A-D, while group 703C of the same width can accommodate three directory entries 717A-C. Directory entries 712A-D are regular entries, and directory entries 717A-C are narrow entries. It is noted that “group”refers to a unit of memory space.

In an implementation, the mixture of regular entries 712A-D and narrow entries 717A-C occurs only between groups, i.e., different group may contain different type of entries, but there is only one type of entry within a particular group. For example, group 703A contains all regular entries 712A-B; and group 703C contains all narrow entries 717A-C.

As shown in FIG. 7, region-based cache directory 700 contains a mixture of regular entries 712A-D and narrow entries 717A-C. In other implementations, the mixture can include more than two sizes of entries; and the region-based cache directory 700 can have a different number of groups catering to a different demand of the computing system.

In an implementation, narrow directory entries 717A-C are used for tracking private cache regions that are exclusively accessed by a single or a small number of core complexes, and thus need fewer number of bits for tracking. Regular directory entries 712A-D are used for tracking, e.g., shared cache regions that are accessed by large number of core complexes. For example, regular directory entries 712A-D are used for tracking eight core complexes, while narrow directory entries 717A-C are used for tracking two core complexes.

It is noted that the mixed entry structure can also be applied to other types of probe filter directories, such as the line-based directory.

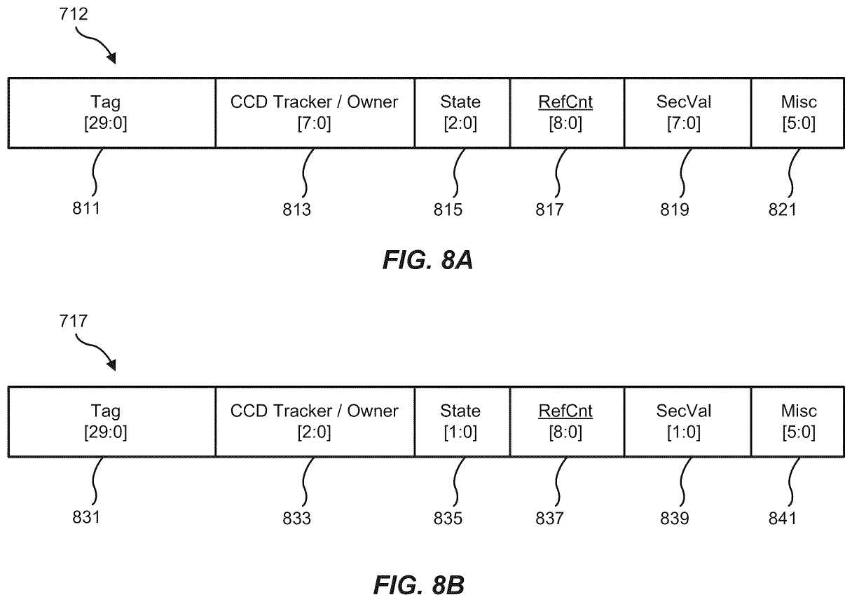

FIGS. 8A and 8B are block diagrams illustrating an exemplary regular directory entry 712 and an exemplary narrow directory entry 717, respectively. Referring to FIG. 8A, regular directory entry 712 includes a tag field 811, a core complex die (CCD) tracker/owner field 813, a state field 815, a reference count (RefCnt) field 817, a sector valid (SecVal) field 819, and a miscellanea (Misc) field 821. CCD tracker/owner field 813 is used to track the directory entry 712 to core complexes which own the cached data identified by the directory entry 712.

As shown in FIG. 8A which shows bit indexes, in an implementation, tag field 811 has 30 bits ([29: 0]); CCD tracker/owner field 813 has 8 bits ([7: 0]); state field 815 has 3 bits ([2: 0]); RefCnt field 817 has 9 bits ([8: 0]); SecVal field 819 has 8 bits ([7: 0]); and Misc field 821 has 6 bits ([5: 0]).

Referring to FIG. 8B, narrow directory entry 717 also has tag field 831, CCD tracker/owner field 833, state field 835, RefCnt field 837, SecVal field 839 and Misc field 841. As narrow directory entry 717 is privately owned by a particular core complex, its CCD tracker/owner field 833 has only 3 bit [2: 0] which is shorter than CCD tracker/owner field 813 of regular directory entry 712. In an implementation, CCD tracker/owner field 833 of narrow directory entry 717 has only two trackers, one for a local socket and one for a remote socket. In comparison, CCD tracker/owner field 813 of regular directory entry 712 has 8 trackers, one for each group. In another implement, narrow directory entry 717 uses a 2-bit state field 835 which is shorter than state field 815 of regular directory entry 712.

In an implementation, narrow directory entry 717 has only one sector valid occupying two bits (SecVal field 839 [1: 0]). In comparison, regular directory entry 712 has eight sector valids occupying 8 bits (SecVal field 819 [7: 0]).

In other implementations, narrow directory entry 717 can use fewer bits for other fields as well, such as RefCnt field 837 and Misc field 841.

FIG. 9 is a flowchart illustrating an exemplary process 900 for increasing the capacity of a probe filter directory (e.g., 500 shown in FIG. 5) by mixing regular (e.g., 712 shown in FIG. 8A) and narrow entries (e.g., 717 shown in FIG. 8B). The process 900 begins with a boot procedure (block 902), in which a first and second group (e.g., 703A-B and 703C, respectively, shown in FIG. 7) of a probe filter directory is allocated to a regular and narrow entry, respectively (block 910). During subsequent operations, if a cache region is accessed by more than a predetermined number of core complexes (block 920)—a shared region, a regular entry is used to track the shared cache region (block 930). If the cache region is accessed by less or equal to a predetermined number of core complexes (block 920)—a private region, a narrow entry is used to track the private cache region (block 940). In an implementation, the predetermined number can be 1.

FIG. 10 is a flowchart illustrating another exemplary process 1000 for increasing the capacity of a probe filter directory (e.g., 500 shown in FIG. 5) by mixing regular (e.g., 712 shown in FIG. 8A) and narrow entries (e.g., 717 shown in FIG. 8B). The process 1000 begins with a boot procedure (block 1002), in which an entire probe filter directory is allocated for regular entries (block 1010). Cache regions are tracked with the regular entries (block 1020) until an occupancy of the probe filter directory reaches a predetermined level (block 1030), then a group of the probe filter directory is re-allocated for narrow entries (block 1040). In implementations, the predetermined level is dynamically determined depending on historic and current cache performances. With the availability of a re-allocated group of narrow entries, if a cache region is accessed by more than a predetermined number of core complexes (block 1050)—a shared region, a regular entry is used to track the shared cache region (block 1020). If the cache region is accessed by less or equal to a predetermined number of core complexes (block 1050)—a private region, a narrow entry is used to track the private cache region (block 1060). In an implementation, the predetermined number can be 1.

Conversely, in an implementation, if the probe filter directory has ample capacities, a group of narrow entries can be converted to a group of regular entries. In an implementation, a private region sitting in a narrow entry is swapped with an empty regular entry if the former is about to go shared. In an implementation, a private region sitting in a narrow entry is swapped with a different private regular entry if the former is about to go shared. Further, a private narrow entry can be disallowed from being shared if there are no spare empty or private regular entries, to avoid issuing multi-case probes with poor fidelity that arise from shared narrow regions by proactively evicting the current owner of that narrow entry.

The present disclosure discloses a probe filter directory that contains a mixture of regular entries and narrow entries. The narrow entry tracks, for example, fewer number of core complexes than the regular entry and thus requires fewer bits. The mixed entry probe filter directory can accommodate more entries than conventional uniform probe filter directory at a same size of data structure.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed. Any of the various computing systems described herein are configured to implement processes described herein.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of. ” Finally, for ease of use, the terms “including” and “having” (and their derivatives), as used in the specification and claims, are interchangeable with and have the same meaning as the word “comprising. ”

What is claimed is:

1. A device comprising:
a probe filter directory having entries for tracking a plurality of memory locations wherein data stored at the plurality of memory locations are cached in a cache subsystem, the probe filter directory including:
a first entry for tracking a first memory location of the plurality of memory locations, the first entry taking up a first number of bits; and
a second entry for tracking a second memory location of the plurality of memory locations, the second entry taking up a second number of bits,
wherein the first number of bits is larger than the second number of bits.

2. The device of claim 1, wherein the second entry is re-allocated from having the first number of bits to having the second number of bits in response to an occupancy of the probe filter directory reaching a predetermined level.

3. The device of claim 1, wherein the first memory location includes a first and second line of the memory, data at the first line being accessed by a first processing node of a system and data at the second line being accessed by a second processing node of the system.

4. The device of claim 3, wherein the first and the second processing node share a bus or fabric.

5. The device of claim 3 wherein data at the second memory location is accessed only by the first processing node.

6. The device of claim 1, wherein the first and second memory locations in the memory are single lines in the memory.

7. The device of claim 1, wherein the first and second entry have a same number of fields, and every field in the first entry has a corresponding field in the second entry.

8. The device of claim 7, wherein a first field in the first entry takes up a larger number of bits than a corresponding field in the second entry while a second field in the first entry takes up a same number of bits as a corresponding field in the second entry.

9. The device of claim 8, wherein the first field is a core complex tracker configured to track a processor that owns the data from at least one of the plurality of memory locations in the memory.

10. The device of claim 1, wherein a first number of the first entries take up a same number of bits as a second number of the second entries, where the first and second number are different integers larger than 1.

11. A system comprising:
a first processing node including one or more processors and a cache subsystem; and
a probe filter directory having entries for tracking a plurality of memory locations wherein data stored at the plurality of memory locations are cached in the cache subsystem, the probe filter directory including:
a first entry for tracking a first memory location of the plurality of memory locations, the first entry taking up a first number of bits; and
a second entry for tracking a second memory location of the plurality of memory locations, the second entry taking up a second number of bits,
wherein the first number of bits is larger than the second number of bits.

12. The system of claim 11, wherein the second entry is re-allocated from having the first number of bits to having the second number of bits in response to an occupancy of the probe filter directory reaching a predetermined level.

13. The system of claim 11, wherein the first memory location includes a first and second line of the memory, data at the first line being accessed by a first processing node of a system and data at the second line being accessed by a second processing node of the system.

14. The system of claim 11, wherein data at the second memory location is accessed only by the first processing node.

15. The system of claim 11, wherein the first and second entry have a same number of fields, and every field in the first entry has a corresponding field in the second entry, wherein a first field in the first entry takes up a larger number of bits than a corresponding field in the second entry, while a second field in the first entry takes up a same number of bit as a corresponding field in the second entry.

16. The system of claim 11, wherein a first number of the first entries take up a same number of bits as a second number of the second entries, where the first and second number are different integers larger than 1.

17. A method comprising:
constructing a first entry of a probe filter directory for tracking a first memory location in a memory, the first entry taking up a first number of bits; and
constructing a second entry of the probe filter directory for tracking a second memory location in the memory, the second entry taking up a second number of bits,
wherein the first number of bits is larger than the second number of bits and data stored at the first and second memory location in the memory are cached in a cache subsystem.

18. The method of claim 17, wherein the constructing the first and second entries are performed during a boot process for a first processing node.

19. The method of claim 17, wherein the constructing the second entry includes re-allocating the second entry from having the first number of bits to having the second number of bits in response to an occupancy of the probe filter directory reaching a predetermined level.

20. The method of claim 17, wherein the first memory location includes a first and second line of the memory, data at the first line being accessed by a first processing node of a system and data at the second line being accessed by a second processing node of the system.
